(19) United States
(12) Patent Application Publication
(10) Pub. No.: US 2025/0111124 A1
(43) Pub. Date: Apr. 3, 2025

(54) CIRCUIT SIMULATION OPTIMIZATION METHOD, DEVICE, COMPUTER DEVICE AND STORAGE MEDIUM

(71) Applicant: XPEEDIC CO., LTD., SHANGHAI (CN)

(72) Inventors: Liguo JIANG, SHANGHAI (CN); Wenliang DAI, SHANGHAI (CN); Yida XU, SHANGHAI (CN); Feng LING, SHANGHAI (CN)

(21) Appl. No.: 18/553,260

(22) PCT Filed: Sep. 15, 2023
(86) PCT No.: PCT/CN2022/118937

§ 371 Date: May 21, 2024

(30) Foreign Application Priority Data
Sep. 16, 2021 (CN) 202111083415.6

(51) Int. Cl. G06F 30/398

(52) U.S. Cl. CPC G06F 30/398

(57) ABSTRACT

A circuit simulation optimization method, device, computer device and storage medium, wherein the circuit simulation optimization method comprises: acquiring initial design parameters of a design circuit, and calculating an initial value of an S-parameter based on the initial design parameters of the design circuit; judging whether the design circuit is qualified according to design requirements according to the initial value of the S-parameter value and a preset S-parameter threshold; when the design circuit is not qualified according to the design requirements, calculating a derivative of an object function corresponding to the S-parameter at the initial design parameters; and searching for a point of a smallest possible value of the object function corresponding to the S-parameter in a preset interval of the initial design parameters according to the derivative.

### TECHNICAL FIELD

The present invention relates to the technical field of computer technologies and specifically a circuit simulation optimization method, device, computer device and storage medium.

### BACKGROUND TECHNOLOGY

With the development of science and technology and improvement of technical levels of electronic products design and production, after circuit design, designers usually simulate the circuit to determine performance of the circuit, and optimize the design of the circuit based on the simulation results. During circuit simulation, usually values of the S-parameter are used to reflect the performance of the design circuit (for example, return loss). The S-parameter, also called scattering parameter, is a network parameter established on the basis of the relationship between an incident microwave and a reflected microwave. The S-parameter is very useful for circuit design, as the ratio between the incident wave and the reflected wave can be used to calculate indicators such as impedance, frequency response and isolation etc. Generally the simulation optimization problems after circuit design can be regarded as searching for a point of the smallest possible value of an object function corresponding to the S-function.

Currently, for simulation optimization of the circuits, the accuracy of determining the point of the smallest possible value of the object function corresponding to the S-function is low and poor circuit simulation optimization effects are achieved.

### SUMMARY OF THE INVENTION

The purpose of embodiments of the present invention is to provide a circuit simulation optimization method, device, computer device and storage medium, and aims to address the technical problem that searching accuracy of a point of the smallest possible value of the object function corresponding to the S-parameter is low and the circuit simulation optimization effect is poor.

The embodiments of the present invention are realized in this manner, the circuit simulation optimization method comprises:

Acquiring initial design parameters of a design circuit, and calculating an initial value of an S-parameter based on the initial design parameters of the design circuit;
judging whether the design circuit is qualified according to design requirements according to the initial value of the S-parameter value and a preset S-parameter threshold;
when the design circuit is not qualified according to the design requirements, calculating a derivative of an object function corresponding to the S-parameter at the initial design parameters; and
searching for a point of a smallest possible value of the object function corresponding to the S-parameter in a preset interval of the initial design parameters according to the derivative.

Another purpose of the present invention is to provide a circuit simulation optimization device, whether the circuit simulation optimization device comprises:
an initial S-parameter value calculation module, configured to acquire initial design parameters of a design circuit, and calculating an initial value of an S-parameter based on the initial design parameters of the design circuit;
a judgment module, configured to judge whether the design circuit is qualified as per design requirements according to the initial value of the S-parameter and a preset S-parameter threshold;
a derivative calculation module, configured to calculate a derivative of an object function corresponding to the S-parameter at the initial design parameters when the design circuit is not qualified according to the design requirements; and
a smallest point searching module, configured to search a point of a smallest possible value of the object function corresponding to the S-parameter in a preset interval of the initial design parameters according to the derivatives.

Another purpose of the present invention is to provide a computer device, wherein the computer device comprises a storage device and a processor, and a computer program is stored in the storage device, and the computer program when executed by the processor will have the processor execute the steps of the foregoing circuit simulation optimization method.

Another purpose of the present invention is to provide a computer readable medium, wherein a computer program is stored on the computer readable medium, and the computer program when executed by a processor, will have the processor execute the steps of the foregoing circuit simulation optimization method.

For the circuit simulation optimization method provided in the present invention, by calculating the initial value of the S-parameter of the design circuit at the very beginning, it is possible to judge whether the initial design parameters of the design circuit are qualified according to the design requirements according to the initial value of the S-parameter of the design circuit, once when the initial design parameters are determined to be not qualified according to the design requirements, design parameters of the design circuit will be optimized to a further extent, and when to optimize the design parameters of the circuit, by calculating firstly the derivative of the object function corresponding to the S-parameter at the initial design parameters, the gradient direction of the object function can be judged, and the smallest possible point can be found along the descending direction of the gradient of the object function, so as to determine optimized design, promise simulation and optimization effects of the design circuits and improve optimization efficiency.

### BRIEF DESCRIPTION OF DRAWINGS

FIG. 1 is a flowchart diagram showing a circuit simulation optimization method as provided in an embodiment of the present invention;

FIG. 2 is a flowchart diagram showing finding a smallest possible point of an object function corresponding to an S-parameter in a preset interval of initial design parameters according to derivatives according to an embodiment of the present invention;

FIG. 3 is a structural flowchart diagram of a circuit simulation optimization device provided in an embodiment of the present invention; and

FIG. 4 is a structural flowchart diagram of a computer device as provided in an embodiment of the present invention.

### EMBODIMENTS

To make purposes, technical solutions and advantages of the present invention more clear, hereinafter a further detailed description will be given to the present invention based on the accompanying drawings and the embodiments. It shall be comprehensible that, the embodiments given here are only used to explain the present invention rather than limit the present invention.

It shall be understood that, terms such as “first” and “second” are used in the description to describe all kinds of elements, however, unless specified otherwise, the elements are not limited by those terms. The terms are only used to differentiate the first element from the second element. For example, without departing from the present invention, the first xx script can be named as the second xx script and similarly the second xx script can be named as the first xx script.

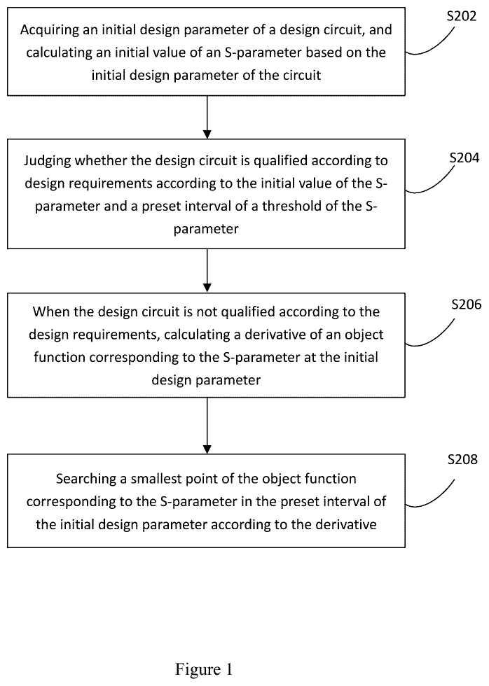

As shown in FIG. 1, in an embodiment, a circuit simulation optimization method is proposed, wherein the circuit simulation optimization method comprises specifically the following steps:

Step S202, acquiring initial design parameters of a design circuit, and calculating an initial value of an S-parameter according to the initial design parameters of the design circuit.

In the present embodiment, the initial design parameters of the design circuit refer to initially assigned values of capacitance and inductance in the circuit after circuit design. In the meanwhile, the initial design parameters have predetermined value intervals, for example, the values of capacitance or inductance shall not be negative or very small. The present embodiment provides the circuit simulation optimization method to find design parameters in the predetermined value intervals of the initial design parameters that can achieve optimum performance of the design circuit.

In the present embodiment, no limitation is given to the specific method to calculate the initial value of the S-parameter according to the initial design parameters of the circuit, for example, the circuit simulator program xspice developed by Xpeedic Co., Ltd. or all kinds of spice circuit simulation calculation software based on the spice simulation algorithm developed by University of California, Berkeley in the USA can be used to obtain the initial values of the S-parameter of the circuit at all frequency points.

Step S204, judging whether the design circuit is qualified according to the design requirements according to the initial value of the S-parameter and a predetermined S-parameter threshold.

In the present embodiment, the design requirements on the design circuit means the design requirements on performance of the design circuit, and the values of the S-parameter of the circuit can reflect the performance of the circuit, the predetermined S-parameter threshold can reflect the design requirement on the design circuit, and by judging whether the initial value of the S-parameter falls into the predetermined interval of the S-parameter threshold whether the design circuit can satisfy the design requirements in condition of the initial design parameters can be judged.

Step S206, when the design circuit is not qualified according to the design requirements, calculating the derivatives of the object function corresponding to the S-parameter at the initial design parameters.

In the present embodiment, that the design circuit is not qualified according to the design requirements means that the initial value of the S-parameter does not fall into the preset the threshold interval of the S-parameter. The object function corresponding to the S-parameter is a tolerance function with no fixed expression obtained according to the design circuit and the design requirements of the design circuit, the independent variable(s) of the tolerance function is/are the design parameter(s), in other words, parameters of the electronic parts that are to be optimized, for example, the values of the capacitance and/or inductance in the design circuit.

In the present embodiment, by calculating the derivatives of the object function corresponding to the S-parameter in condition of the initial design parameters, the gradient condition of the object function at the initial design parameters can be judged. In the present embodiment, no limitation is given to the specific methods as to how to calculate the derivatives of the object function corresponding to the S-parameter in condition of the initial design parameters, for example, substitution of differentiation approximations with derivatives, for example, when there are n independent variables, recording an initial point to be {x₁, x₂, . . . , xᵢ+e, . . . , xₙ} and an initial tolerance f₀, selecting a smaller value e, and the recommended value is 1e-6. Calculating fᵢ to be the tolerances at the points {x₁, x₂, . . . xᵢ+e, . . . , xₙ}. By differentiation partial derivatives

$${f}_{i} ’ = \frac{{f}_{i} - {f}_{0}}{e}$$

can be approximated, vectors g=(f′₁, f′₂, . . . , f′ₙ) are the derivatives at the points. Algorithms such as central differentiation can also be used for more accurate gradient approximation values.

Step S208, searching a point of the smallest possible value of the object function corresponding to the S-parameter according to the derivatives in a preset interval of the initial design parameters.

In an embodiment of the present invention, the derivatives of the object function corresponding to the S-parameter at the initial design parameters can be used to determine the gradient of the object function at both left and right sides of the initial design parameters, so that the point of the smallest possible value of the object function corresponding to the S-parameter can be found in the preset interval of the initial design parameters along a negative direction of the gradient.

In the present embodiment, the specific methods used to search the point of the smallest possible value of the object function corresponding to the S-parameter according to the derivatives in the preset interval of the initial design parameters are not restricted, as shown in FIG. 2, step S208 can include the following steps:

Step S302, determining the descending direction of the gradient of the object function corresponding to the S-parameter according to the derivatives.

In an embodiment of the present invention, when the derivatives of the object function corresponding to the S-parameter at the initial design parameters are positive numbers, the descending direction of the gradient of the object function is at the left side of the initial design parameter, when the derivatives of the object function corresponding to the S-parameter at the initial design parameters are negative, the descending direction of the gradient of the object function is located at the right side of the initial design parameters.

Step S304, determining a one-variable function according the descending direction of the object function corresponding to the S-parameter.

In an embodiment of the present invention, the tolerance function in a given frequency interval cannot be expressed in an expression of a basic primary function, therefore, the tolerance function is recorded as f(X), an initial point of each iteration is marked as X₀, the descending direction of the gradient is −g(X₀), wherein X is a vector. As subsequently the search is done downwards along the gradient direction, only the values of the object function along the X₀−t*g(X₀) is calculated, that is, only the one-variable function f(X₀−t*g(X₀)) is considered.

Step S306, calculating the interval [a, b] of the one-variable function according to the preset interval of the initial design parameter, and calculating respectively the function values f0, f1 and f2 at a, d1 and d2, wherein d1 and d2 fall into the interval [a, b].

In an embodiment of the present invention, regarding the interval [a, b], an initial point a is recorded as 0 and the range of the independent variable that a user inputs is:

$$\{ ( {x}_{1}^{min} , {x}_{1}^{max} ) , ( {x}_{2}^{min} , {x}_{2}^{max} ) , … , ( {x}_{n}^{min} , {x}_{n}^{max} ) \} ;$$

Wherein, (xᵢ^{min}, xᵢ^{max}) means that a lower limit of xᵢ is xᵢ^{min} and an upper limit of xᵢ is xᵢ^{max}. Take gᵢ as the ith component of the gradient, b can be calculated with the following formula:

$$3 b = min {b}_{i} ,$$

$${b}_{i} = \{ \begin{matrix}\frac{{x}_{i} - {x}_{i}^{min}}{{g}_{i}} , {g}_{i} > 0 \\ \frac{{x}_{i}^{max} - {x}_{i}}{{g}_{i}} , {g}_{i} < 0 \\ largest theoretical number in a computer DBL\_MAX , {g}_{i} = 0\end{matrix} ;$$

Wherein f0 is the function value of the left end point a in the interval [a, b], f1 is a function value of the point d1 in the interval [a, b], and f2 is a function value of the point d2 in the interval [a, b]. preferably, the point 0.382 in the interval [a, b] is taken as d1, the point 0.618 in the interval [a, b] is taken as d2, that is, a ratio between the length of the interval [a, d1] and the length of the interval [a, b] is 0.382, and a ratio between the length of the interval [a, d2] and the length of the interval [a, b] is 0.618, and by selecting the d1, d2 to be the golden cut point of the interval [a, b], the searching speed of the smallest possible point can be effectively improved and calculation work can be reduced. For example, if cut with other values, for example, cut at one third, for each calculation the one third point and the two third point in the new interval shall be calculated, that is, for each time of calculation, two points are to be calculated, and the point that has been calculated previously cannot be utilized. And by using the golden cut point, for each calculation only one point is to be calculated, taking advantage of the property of golden cut, d1 in the interval [a, d2] is the point 0.618 and d2 in the interval [d1, b] is the point 0.382, in this way, in a new interval only one value of the object function is to be calculated.

Step S308, determining a point of the smallest possible value of the object function corresponding to the S-parameter according to the function values f0, f1 and f2.

In an embodiment of the present invention, the specific methods for calculating the point of the smallest possible value of the object function corresponding to the S-parameter according to the function values f0, f1 and f2 are not restricted, for example, the step S308 can comprise the following steps:

Step S402, judging whether f1 is smaller than f0.

Step S404, when f1 is not smaller than f0, taking an interval of the one-variable function to be [a, d2].

In an embodiment of the present invention, when f1 is not smaller than f0, judging that the one-variable function is non-convex, at this time, change the left end point value of the interval of the one-variable function to be d2.

Step S406, when f1 is smaller than f0, judging whether f1 is bigger than f2, when f1 is bigger than f2, taking the interval of the one-variable function to be [d1, b], when f1 is not bigger than f2, judging the interval of the one-variable function to be [a, d2].

In an embodiment of the present invention, when f1 is bigger than f2, according to requirements of the gradient descending algorithm, a value smaller than the function value is found, at this time, satisfying the iteration step of the gradient descending algorithm, and to improve accuracy, find the biggest descending point, the object function is convex at the given three points, then the interval of the one-variable function is [d1, b], otherwise, the smallest possible value falls into the interval [a, d2].

Step S408, judging whether the interval [d1, b] or [a, d2] of the one-variable function satisfies the termination condition;

In an embodiment of the present invention, judging whether the interval [d1, b] or [a, d2] satisfies the termination condition, that is, judging whether the d1 or d2 satisfies the predetermined accuracy requirement, if during iteration, the newly calculated d1 and d2 satisfy the accuracy requirement input by the user, jump out of the iteration output result.

Step S410, when the terminating condition is not satisfied, taking the point 0.382 and the point 0.618 of the one-variable function interval [d1, b] or [a, d2], and calculating function values of the point 0.382, the point 0.618 and the left end point of the interval [d1, b] or [a, d2];

Step S412, determining the point of the smallest possible point of the object function corresponding to the S-parameter according to the function values of the point 0.382, the point 0.618 and the left end point of the interval [d1, b] or [a, d2].

In an embodiment of the present invention, when the foregoing termination condition is not met, the iteration step will recur the step S306 until the step S308, until the point of the smallest possible value is determined; apparently, when the foregoing termination condition is met, update the value of the design parameter and continue with the smallest point searching.

The embodiments of the present invention provide a circuit simulation optimization method, by first calculating the initial value of the design circuit, whether the initial design parameters of the design circuit can satisfy the design requirements can be judged according to the initial value of the S-parameter of the design circuit, only when the initial design parameter cannot satisfy the design requirements, optimize the design parameter of the design circuit to a further extent, and during optimization of the design parameter of the design circuit, by first calculating the derivatives of the object function corresponding to the S-parameter at the initial design parameters, the gradient direction of the object function can be judged, after that, the smallest point can be searched along the descending direction of the gradient of the object function, so as to determine optimized design, promise the simulation optimization effects of the design circuit and improve optimization efficiency.

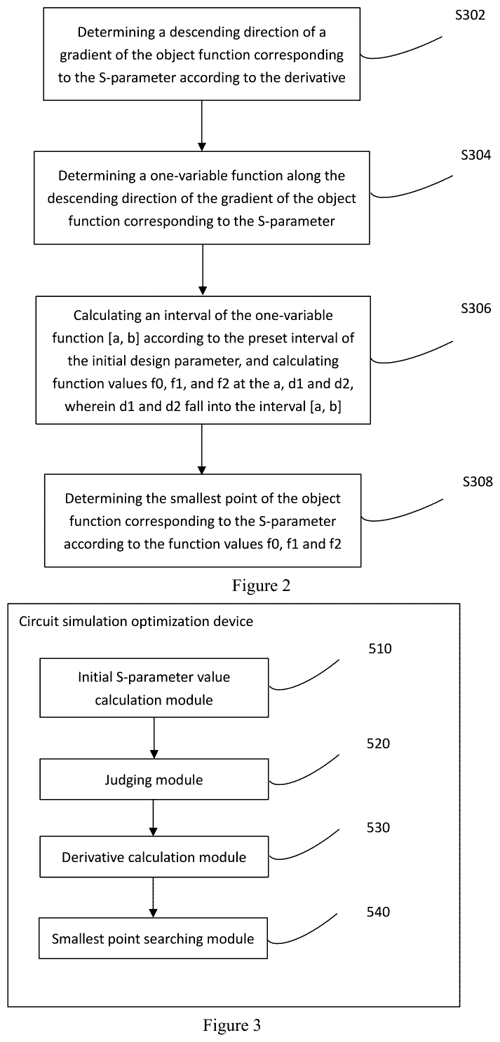

As shown in FIG. 3, in an embodiment, a circuit simulation optimization device is provided, wherein the circuit simulation optimization device can be integrated in a computer device, specifically, the circuit simulation optimization device comprises an initial S-parameter value calculation module 510, a judging module 520, a derivative calculation module 530 and a smallest point searching module 540.

The initial S-parameter value calculation module 510 is configured to acquire initial design parameters of the design circuit, and calculating an initial value of the S-parameter according to the initial design parameters of the circuit;
the judging module 520 is configured to judge whether the design circuit satisfies the design requirements according to the initial value of the S-parameter and a preset S-parameter threshold;

The derivative calculation module 530 is configured to calculate derivatives of the object function corresponding to the S-parameter at the initial design parameters; and

The smallest point searching module 540 is configured to search the smallest point of the object function corresponding to the S-parameter at the preset interval of the initial design parameters according to the derivative.

In an embodiment of the present invention, the initial S-parameter value calculation module 510, the judging module 520, the derivative calculation module 530 and the smallest point searching module 540 correspond respectively to the step S202, the step S204, the step S206 and the step S208, and for explanation of the specific functions of each of the modules please refer to the description of the simulation optimization method in the present invention and in the present embodiment the description will not be repeated here.

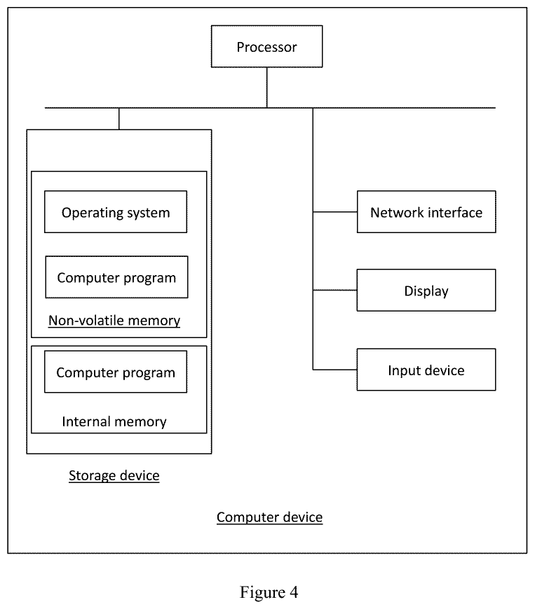

FIG. 4 shows an internal structural diagram of a computer device as provided in an embodiment of the present invention. As shown in FIG. 4, the computer device comprises a processor, a storage device, a network interface, an input device and a display that are connected by a system bus. In the computer device, the storage device comprises a non-volatile storage medium and an internal memory. An operation system is stored in the non-volatile storage medium of the computer device, a computer program can be stored therein too, and the computer program when executed by the processor, will have the processor to conduct the circuit simulation optimization method. A computer program is stored in the internal storage device, and the computer program when executed by the processor, will have the processor to execute the circuit simulation optimization method. The display of the computer device can be a liquid crystal display or an electronic ink display, the input device of the computer device can be a touch layer covered on the display, and can also be keys, track balls or touch pads connected on the casing of the computer device, and the input device can also be a key board, a touch pad or a mouse that is connected with the computer device.

Those skilled in the art can appreciate that, in FIG. 4 only a diagram showing some structures related to the technical solution of the present invention is disclosed, and the structures disclosed in FIG. 4 do not form any restriction on the application of the present invention on the computer device, specifically, the computer device can include more or less parts than those shown in the drawings, some parts can be combined or arranged in different manners.

In an embodiment of the present invention, the circuit simulation optimization device provided in the present invention can be realized in the form of a computer program and the computer program runs in a computer device as shown in FIG. 4. The storage device of the computer device is stored with modules of the computer program that form the circuit simulation optimization device, for example, the initial S-parameter value calculation module, the judging module, the derivative calculation module and the smallest point searching module. The computer program formed by the modules can have the processor to execute the steps in the circuit simulation optimization method disclosed in embodiments of the present invention.

For example, the computer device as shown in FIG. 4 can have the initial S-parameter value calculation module in the circuit simulation optimization device as shown in FIG. 3 to execute the step S202. The computer device can have the derivative calculating module to execute the step S206. The computer device can have the smallest point searching module to execute the step S208.

In an embodiment, a computer device is provided, wherein the computer device comprises a storage medium, a processor and a computer program stored in the storage device and can be operated by the processor and the processor can realize the foregoing steps when executing the computer program:
Step S202, acquiring an initial design parameter of a design circuit, and calculating an initial value of an S-parameter based on the initial design parameter of the circuit;
Step S204, judging whether the design circuit is qualified according to design requirements according to the initial value of the S-parameter and a preset S-parameter threshold;
Step S206, calculating a derivative of the object function corresponding to the S-parameter at the initial design parameter when the design circuit is not qualified according to the design requirements; and
Step S208, searching a point of the smallest possible value of an object function corresponding to the S-parameter in the preset interval of the initial design parameter according to the derivative.

In an embodiment, a computer readable storage medium is provided, wherein a computer program is stored in the computer readable storage medium and the computer program when executed by the processor will have the processor to execute the following steps:
Step S202, acquiring an initial design parameter of a design circuit, and calculating an initial value of an S-parameter based on the initial design parameter of the circuit;
Step S204, judging whether the design circuit is qualified according to design requirements according to the initial value of the S-parameter and a preset S-parameter threshold;
Step S206, calculating a derivative of the object function corresponding to the S-parameter at the initial design parameter when the design circuit is not qualified according to the design requirements; and
Step S208, searching a point of a smallest possible value of an object function corresponding to the S-parameter in the preset interval of the initial design parameter according to the derivative.

It shall be understood that, although the steps in the flowchart diagrams of the embodiments of the present invention are shown sequentially as per the arrows, those steps are not necessarily executed sequentially as per the sequences indicated by the arrows. Unless expressly indicated otherwise, there is no strict sequence limitation on the execution of the steps, and the steps can be executed in other sequences. Furthermore, at least some of the steps of the embodiments can include more than one sub-step or more than one stage, and the sub-steps or the stages are not necessarily executed at the same time and can be executed at different times, and the execution sequences of the sub-steps or the stages are not necessarily sequential and instead can be executed alternately or in turn with other steps or sub-steps or stages of the other steps.

Those of ordinary skill in the art can understand that all or some of the processes of the method in the embodiments of the present invention can be realized in the form of computer programs to instruct corresponding hardware, and all the programs are stored in a non-volatile computer readable storage medium, and the programs when executed can include the processes as provided in the method as provided in the embodiments of the present invention. In the present invention, any citation to the storage medium, storage, database or other medium used in embodiments of the present invention comprises both non-volatile and/or volatile storage devices.

Non-volatile storage devices can include read-only media (ROM), programmable read-only media (PROM), electronic programmable ROM (EPROM), electronic erasable programmable ROM (EEPROM) and flash memory. Volatile storage devices can include random access memory (RAM) or external high speed cache memory. For explanation rather than limitation, RAM is obtainable in a plurality of forms, for example, static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), Rambus direct RAM (RDRAM), direct Rambus dynamic RAM (DRDRAM), Rambus dynamic RAM (RDRAM) etc.

The technical features in the foregoing embodiments can be arbitrarily combined and to ease description, not all possible combinations of the technical features of the foregoing embodiment have been described, however, in case no contradictory will occur, the combinations of the technical features shall be considered to fall into the scope of the present invention.

The foregoing are only some embodiments of the present invention and the description is specific and detailed, however, the description shall not be construed as limitation on the scope of the present invention. It shall be pointed out that, for those of ordinary skill in the art, without departing from the spirit of the present invention, some modifications and improvements can be made and all of them fall into the protection scope of the present invention. Therefore, the protection scope of the present invention shall be subject to the appended claims.

The foregoing are only some preferred embodiments of the present invention, and are not intended to limit the present invention, all modifications, equivalent replacement and modifications made within the spirit and principle of the present invention shall fall in to the protection scope of the present invention.

1. A circuit simulation optimization method, comprising:
acquiring initial design parameters of a design circuit, and calculating an initial value of an S-parameter based on the initial design parameters of the design circuit;
judging whether the design circuit is qualified according to design requirements according to the initial value of the S-parameter value and a preset S-parameter threshold;
when the design circuit is not qualified according to the design requirements, calculating a derivative of an object function corresponding to the S-parameter at the initial design parameters; and
searching for a point of a smallest possible value of the object function corresponding to the S-parameter in a preset interval of the initial design parameters according to the derivative.

2. The circuit simulation optimization method according to claim 13, wherein d1 and d2 are respectively a point 0.382 and a point 0.618 in the interval [a, b].

3. The circuit simulation optimization method according to claim 13, wherein determining the point of the smallest possible value of the object function corresponding to the S-parameter according to the function values f0, f1 and f2 comprises:
judging whether f1 is smaller than f0;
when f1 is not smaller than f0, taking an interval of the one-variable function to be [a, d2];
when f1 is smaller than f0, judging whether f1 is bigger than f2, when f1 is bigger than f2, taking the interval of the one-variable function to be [d1, b], when f1 is not bigger than f2, judging the interval of the one-variable function to be [a, d2];
judging whether the interval [d1, b] or [a, d2] of the one-variable function satisfies a termination condition;
when the terminating condition is not satisfied, taking the point 0.382 and the point 0.618 of the interval of the one-variable function [d1, b] or [a, d2], and calculating function values of the point 0.382, the point 0.618 and the left end point of the interval [d1, b] or [a, d2]; and
determining the point of the smallest possible point of the object function corresponding to the S-parameter according to the function values of the point 0.382, the point 0.618 and the left end point of the interval [d1, b] or [a, d2].

4. A circuit simulation optimization device, comprising:
an initial S-parameter value calculation module, configured to acquire initial design parameters of a design circuit, and calculating an initial value of an S-parameter based on the initial design parameters of the design circuit;
a judgment module, configured to judge whether the design circuit is qualified as per design requirements according to the initial value of the S-parameter and a preset S-parameter threshold;
a derivative calculation module, configured to calculate a derivative of an object function corresponding to the S-parameter at the initial design parameters when the design circuit is not qualified according to the design requirements; and
a smallest point searching module, configured to search a point of a smallest possible value of the object function corresponding to the S-parameter in a preset interval of the initial design parameters according to the derivatives.

5. A computer device, wherein the computer device comprises a storage device and a processor, and a computer program is stored in the storage device, and the computer program when executed by the processor will have the processor execute the steps of the foregoing circuit simulation optimization method as recited in claim 1.

6. A non-transitory computer readable medium, wherein a computer program is stored on the non-transitory computer readable medium, and the computer program when executed by a processor, will have the processor execute the steps of the foregoing circuit simulation optimization method as recited in claim 1.

7. A computer device, wherein the computer device comprises a storage device and a processor, and a computer program is stored in the storage device, and the computer program when executed by the processor will have the processor execute the steps of the foregoing circuit simulation optimization method as recited in claim 13.

8. A computer device, wherein the computer device comprises a storage device and a processor, and a computer program is stored in the storage device, and the computer program when executed by the processor will have the processor execute the steps of the foregoing circuit simulation optimization method as recited in claim 2.

9. A computer device, wherein the computer device comprises a storage device and a processor, and a computer program is stored in the storage device, and the computer program when executed by the processor will have the processor execute the steps of the foregoing circuit simulation optimization method as recited in claim 3.

10. A computer readable medium, wherein a computer program is stored on the computer readable medium, and the computer program when executed by a processor, will have the processor execute the steps of the foregoing circuit simulation optimization method as recited in claim 13.

11. A computer readable medium, wherein a computer program is stored on the computer readable medium, and the computer program when executed by a processor, will have the processor execute the steps of the foregoing circuit simulation optimization method as recited in claim 2.

12. A computer readable medium, wherein a computer program is stored on the computer readable medium, and the computer program when executed by a processor, will have the processor execute the steps of the foregoing circuit simulation optimization method as recited in claim 3.

13. The circuit simulation optimization method according to claim 1, wherein searching for a point of a smallest possible value of the object function corresponding to the S-parameter in a preset interval of the initial design parameters according to the derivative step comprises:
determining a descending direction of a gradient of the object function corresponding to the S-parameter according to the derivatives;
determining a one-variable function according the descending direction of the gradient of the object function corresponding to the S-parameter;
calculating the interval [a, b] of the one-variable function according to the preset interval of the initial design parameters, and calculating respectively function values f0, f1 and f2 at a, d1 and d2, wherein d1 and d2 fall into an interval [a, b]; and
determining the point of the smallest possible value of the object function corresponding to the S-parameter according to the function values f0, f1 and f2.
